(19) United States
(12) Patent Application Publication
(10) Pub. No.: US 2003/0225701 A1
(43) Pub. Date: Dec. 4, 2003

(54) System for protecting and managing digital contents

(76) Inventors: Won Ha Lee, Seoul (KR); Ji Sun Seo, Seoul (KR); Jong Uk Choi, Seoul (KR)

Correspondence Address: Stephen M. De Klerk, BLAKELY, SOKOLOFF, TAYLOR & ZAFMAN LLP, Seventh Floor, 12400 Wilshire Boulevard, Loa Angeles, CA, 90025-1026, US

(21) Appl. No.: 10/375,181

(22) Filed: Feb. 26, 2003

(30) Foreign Application Priority Data
Feb. 28, 2002 (KR) 2002-11077

(51) Int. Cl. G06F 17/60

(52) U.S. Cl. 705/57

(57) ABSTRACT

A system for protecting copyright and content itself of digital contents generated with respect to their publication and distribution according to the means of wire/wireless communication, internet or off-line. First, digital contents inclusive of specific form of encrypted keys are received. A user compares such receipt with system information indicating characteristics of his/her unique system he/she is using, and when the compared information corresponds to each other, the digital contents are generated. The digital contents received in this regard are provided in a encrypted state according to the user's system information, and the digital contents are generated from extraction of decryption keys of the digital contents and from decryption of specific material among the digital contents. Accordingly, use only in the pertinent system is permitted so as to prevent illegal use of the contents.

### BACKGROUND OF THE INVENTION

The present invention is related to a system for protecting, preserving and managing digital contents. Particularly, the present invention is related to a system for protecting, preserving and managing digital contents using characteristics of user's system.

Recently, an opportunity to easily obtain desired information in comparison to the past has been rendered due to growth of internet and digitalization of various contents. However, need for a technique protecting contents due to easy duplication and circulation is rapidly growing. Accordingly, as a plan in this regard, digital rights management (hereinafter, “DRM”) for protecting, preserving and managing digital contents, i.e. technique for preventing illegal use of the circulating digital contents, and for continuously preserving and managing rights and interests of owners of the related copyright and license rendered with respect to the use of the protected contents, and technique with regard to the field of service are being developed.

Concerning the protection of the digital contents, the technique protecting digital technique includes digital rights management (DRM), digital watermarking, digital object identifier (DOI) and interoperability of data in e-commerce system, etc.

The digital watermarking technique is a technique widely used in corroborating the copyright by inserting information related to the copyright within the contents so as to protect the copyrights. Nevertheless, the digital watermarking technique has a problem of not being able to protect the contents when the digital contents are intercepted to be duplicated and distributed in the computer or other portable device (PD) at the very time while they are being played. That is, the digital watermarking technique does not prevent the duplication or circulation of the contents beforehand, but is adopted as a technique corroborating ownership or copyright of the contents illegally duplicated and circulated afterwards.

Thus, a technique for satisfying the needs of the contents providers and producers for further complete protection of their copyrights is demanded.

As an identifier continuously existing in the contents, the Association of American Publishers (AAP) has designated international serial book number (ISBN) for an independent volume and international serial series number (ISSN) for periodical publications under the digital object identifier (DOI) which is a system processing the identifier on the internet for circulating service. In DOI, the contents can be directly indicated, and thus a structure managing digital contents independent of the position is possible. The DOI assumes the use of public identifiers to enable various application and local uses. Also, the DOI, like other information identifier, is independent with regard to particular application so as to enable free use by large number of users.

Meanwhile, the IDECS is a project supervised by Europe unlike the DOI which was accomplished under the supervision of the United States. The core of the INDECS project which is a joint international project for developing frame work of the meta-data standards to support network commercial exchange of the intellectual property is to develop a single data model for the intellectual property and to develop a standardized structure capable of describing and identifying participants and the tasks of commercial exchange with the intellectual properties. The meta-data standards are being suggested and developed from such data model.

The DRM refers to a technique preventing illegal circulation and duplication of the multi-media contents, and enabling use of contents only for rightful users simultaneously with managing copyright of the multi-media contents through user management, overcharging billing service, etc. The function of the DRM can be largely considered as in division of two categories; protection of the digital contents and management of usage rules, and management of overcharging system. According to the companies possessing the DRM technique, different methods are utilized for developing technique.

To sum up, the digital contents according to the DRM technique are protected through a process of encryption in order to prevent illegal distribution or illegal use of the contents throughout the entire processes from the generation to distribution, use and disposal. The DRM enables only the rightful users having the encrypted key to decrypt the encrypted contents for their use, and even at the illegal distribution, the contents cannot be used without the key.

That is, such protection can be considered a system of giving a key to user after locking the digital contents in a safe and delivering the safe to the user. The user can open the safe with key only when using the contents, but cannot treat the contents directly. The contents are always locked up in the safe, and when using the contents, key is used and the contents are brought out in a stream format. The management of usage rule is also simultaneously made.

Usage rule indicates individual's personal usage rule and rights when circulating and using the contents, but does not directly relate to protection of copyright of the digital contents. The usage rule is capable of effective provision of contents through management of free rules such as addition or revision, etc according to the redistribution of the digital contents. The users can use contents according to the permitted regulation only.

Next, the management of overcharging system is working at the same time. Specifically, the record of use of the digital contents is managed, and based on this management, a task of managing approving the overcharge and approval is performed. The fee for using the contents is levied under the automatic connection with the finance approval system according to the user's authentication.

The most important matter for such DRM is a technique for encrypting the contents, and generally, 128 bit encryption is used. According to the safety and security of the DRM encryption technique, the protection and management of the copyright of the contents become easy. In this regard, an encryption method developed by Intertrust of the United States is the most widely used technique.

The DRM is perceived as a very realistic solution for protecting and managing copyrights of the digital contents in the current market. However, the existing DRM developed and commercially used has a very complicated system that is excessively large, and thus a contents service provider actually cannot easily apply this system and provide service.

Furthermore, in many cases, a problem in managing the authentication key used in the general users' actual purchase, generation and playing of the contents is entirely managed by the DRM server providers' side. Also, in many cases, the actual contents are registered and managed by the server providers' side. Thus, from the standpoint of the contents provider (CP), the aspects of the system construction and the actual contents management contain many vexatious sides. When the encryption surrounding the contents is actually broken in case of DRM, there is a danger in easy circulation of the source contents.

### SUMMARY OF THE INVENTION

In order to solve the problem contained in the contents protection system, the object of the present invention is to provide a system for integral contents protection and management which improved the level of the content management and security when circulating.

Also, the other object of the present invention is to provide a system for protecting and managing contents by using characteristics of user's unique system which the user uses in order to protect the contents.

The other object of the present invention is to suggest a method for more complete protection and management of the copyright by furnishing a first level protection of the contents based on the watermarking technique, and a system of authentication and verification of copyright, and by safely managing and distributing the contents protected at the first level, and to provide an ‘integral contents management system (hereinafter, “CMS”)’ through browser, and hardware control device for preventing illegal use of the contents.

In order to achieve the above objects, the present invention provides a system for protecting and managing digital contents, comprising: at least one user system on which means for generating a unique key is provided, the unique key being determined from a unique information of the user system; a digital contents provider which contains a plurality of digital contents; and a contents protection manager for encrypting a encryption key used to encrypt the digital contents and usage rule on the digital contents with the unique key and combining them with the digital contents, thereby providing a combined data to the user system.

The present invention having the above characteristics basically seeks to provide a system for protecting and managing digital contents throughout the entire processes of generation, distribution, and disposal, i.e. a process from the instance the digital contents (digital copyright) are created to a process whereby various users use the work through certain paths via network or via off-line, and an instance the work is disposed.

The present invention suggests a comprehensive management system with regard to a process the digital copyrights are circulated, which permits right to use the work to the users by a legal manner while protecting the copyright of the digital work so as not to steal, forge, and alter the work at will.

### BRIEF DESCRIPTION OF THE DRAWINGS

FIG. 1 is a block diagram schematically illustrating process of request and distribution of the digital contents according to the present invention.

FIG. 2 is a functional block diagram illustrating the detailed architecture of system for protecting and managing the digital contents according to the present invention.

FIG. 3 is a schematic block diagram illustrating the architecture for user registration of the contents protection system of FIG. 2.

FIG. 4 is a block diagram illustrating the function of user program downloaded to the user system and executed for user registration in FIG. 3.

FIG. 5 is a functional block diagram illustrating architecture of key management server in FIG. 2.

FIG. 6 is a block diagram illustrating uploading process of the digital contents.

FIG. 7 is a functional block diagram illustrating architecture of rule management server in FIG. 2.

FIG. 8 is a functional block diagram illustrating architecture of super distribution management server in FIG. 2.

FIG. 9 illustrates an example for the architecture of the digital contents that will be downloaded to the user system.

FIG. 10 is a flow chart showing process in the user system against the digital contents to be downloaded according to the present invention.

FIG. 11 is a flow chart showing a series of process according to the operation of the function controller related to digital contents manipulation provided according to the present invention.

### DETAILED DESCRIPTION OF A PREFERRED EMBODIMENT

Hereinbelow, a detailed description of the system for protecting and managing digital contents according to the present invention is presented in reference to the attached drawings.

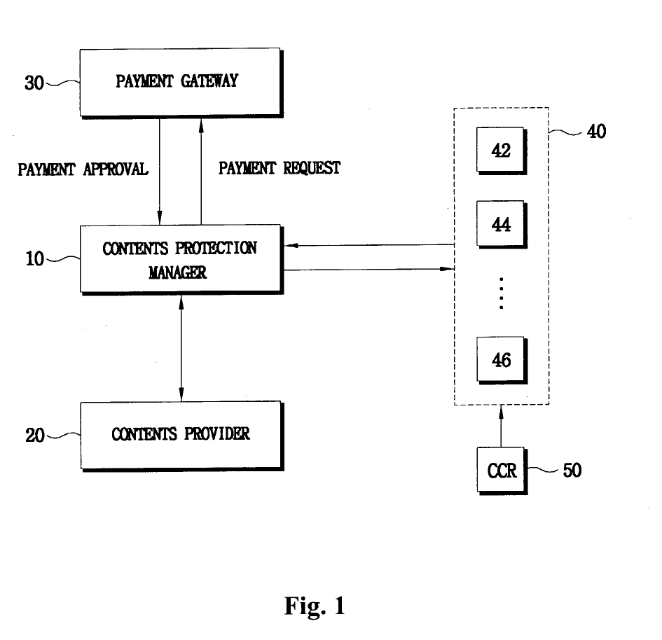

FIG. 1 is a block diagram, which is schematically illustrated about process of request and distribution of the digital contents according to the present invention. In FIG. 1, 10 is a contents protection manager (hereinafter, “CPM”) performing functions of protecting and managing the contents. 20 is a contents provider (hereinafter, “CP”; or contents provider system) providing contents by using this service or a contents distributor (hereinafter, “CD”; contents distributor system). 30 is a payment gateway settling payment related matters such as response to payment requests and payment approval. 40 comprises a user system with a contents consumer (CC) purchasing contents. 50 is a contents controller (CCR) controlling additional functions related to protection of contents functionally in terminals of user's system and on the browsers (for example, functions such as message hooking or clipboard deletion, etc.).

With regard to the contents provider (20) in the above system for protecting and managing digital contents, CP and CD will not be differentiated from each other hereinbelow, and be referred to as CD by integrating their functions. Also, a series of cases occurred in the CD (20)'s side has generated from the contents providers' side, in which the contents provider may be contents producer or be contents provider in ownership of the content's license. Such CD (20) may also be equipped with contents database storing the contents, and a file server in order to provide such contents to the CC (40)'s side. Also, CD (20) may comprise a single system including CPM (10) or a system furnishing contents by a means of connection such as internet externally that is separate from the CPM (10).

CPM (10) grants right to use with regard to the pertinent digital contents to users who paid fees through the succeeding series of processes. When the contents request is made from the CC (40) which undergone a user registration process, the service is provided from the key management server (KMS) for authenticating user and encrypting contents within the CPM (10).

FIG. 1 illustrates the above tasks in a separate state by providing examples. First, the encrypted contents are saved in the CD (20). The CPM (10) saves and manages the encryption key and user key, and manages rules imposed upon the digital contents that will be furnished to CC (40). The CC (40) peruses the digital contents which are stored in CD (20) and be furnished from CD (20) by CPM (10), through means of web via internet or of off-line. (At this time, CC (40) is installed with CCR (50) performing a function to prevent illegal use of the digital contents on web of the home page so as to let the user only peruse the contents, but not to illegally store or duplicate for their own use). CC (40) will purchase digital contents from CD (20) through membership registration and user authentication process. At this time, the user authentication can include authentication using ID and password when joining as member or authentication by notarized certification.

With regard to payment incurred in using the digital contents through the aforementioned processes, CPM (10) furnishes various usable payment conditions to CC (40) in connection with the payment gateway (30), and according to CC (40), materials regarding the selected payment condition is transmitted to the payment gateway (30). The payment gateway (30) inspects data regarding the payment condition, and when the payment condition corresponds to the condition legally payable according to the pertinent condition, the payment gateway (30) transmits signals of approval of payment to CPM (10). Furthermore, a billing list which contains details regarding payment in the aforementioned manner is transmitted to CD (20) in real-time or in predetermined periods of time.

As described above, if authentication of the purchaser, CC (40) against the request of contents from CPM (10) including payment for using the digital contents, etc. is carried out through CPM (10) and the payment gateway (30), etc., the contents provided by CD (20) can be received through a procedure such as downloading. User A (42) who purchased the digital contents may receive a key to decrypt the digital contents after the user authentication so as to decrypt the digital contents and generate or use them.

When User A (42) distributes the digital contents he purchase to User B (44) or User C (46) who are not purchasers, User A (42) may transmit the encrypted digital contents he/she purchased to other users, but User B (44) or User C (46) cannot decrypt the digital contents which User A (42) purchased legally so as to generate or use them. That is, when User B (44) or User C (46) desires to use the pertinent digital contents, he/she should receive a user authentication together with registration as an access user to the service such as User A (42), and should obtain right to use the contents through a series of process.

For reference, CCR (50) performs a preventive function of actions such as illegal use or illegal surreptitious use, etc. against the digital contents by illegal users in respect of uploading various lists and sample contents, etc for peruse of the digital contents which can be purchase by and are usable to the users by using internet home page, etc. The functional performance by CCR (50) can be conducted by installing a separate program on the sides of CD (20) and CC (40). The users in perusing the digital contents provided from CD (20), cannot illegally carry out actions such as saving or duplicating the contents, but may perform a function of delivering only the digital contents protected by CPM (10) to CC (40) at the actual purchase. The details of CCR (50)'s function will be explained later.

The basic function of CPM (10) is to protect the digital contents, and to manage or protect copyrights, etc. of the related contents through encryption process in order to prevent illegal distribution or illegal use of the digital contents throughout the whole process from generation to distribution, use, and disposal of the digital contents. The rightful users with encrypted keys can decrypt and use the encrypted digital contents, and although illegally circulated, the digital contents can be protected by preventing usage when the decryption key does not exist.

CC (40) uses key only when using the digital contents, and the digital contents are always encrypted so as to exist in the closed/locked state, and when the contents are being used, the contents are provided in the usable form by using key. At such, the usable form may include a format of streaming form. The rules regarding contents use in such distribution and circulation system of contents can be installed on the CPM (10)'s side, which indicates each individual user's usage rules and rights when contents are circulated and used, but does not have a direct relation to the copyright protection of the digital contents. According to the usage rules, free management of rules such as addition or revision, etc. according to the re-distribution enables effective provision of contents. Users definitely may use contents pursuant to the permitted rules.

Next, management section of overcharge system manages the details of the use of the digital contents, and based on this, performs a function capable of managing overcharge and approval. Automatic link to the finance approval system according to the user authentication can be designed to levy fees for using the contents and to link interface of overcharge block with modules.

The function of CPM (10) of the system comprised with the aforementioned digital contents as an intermediary is presented hereinbelow with more specific details in reference to the below figure.

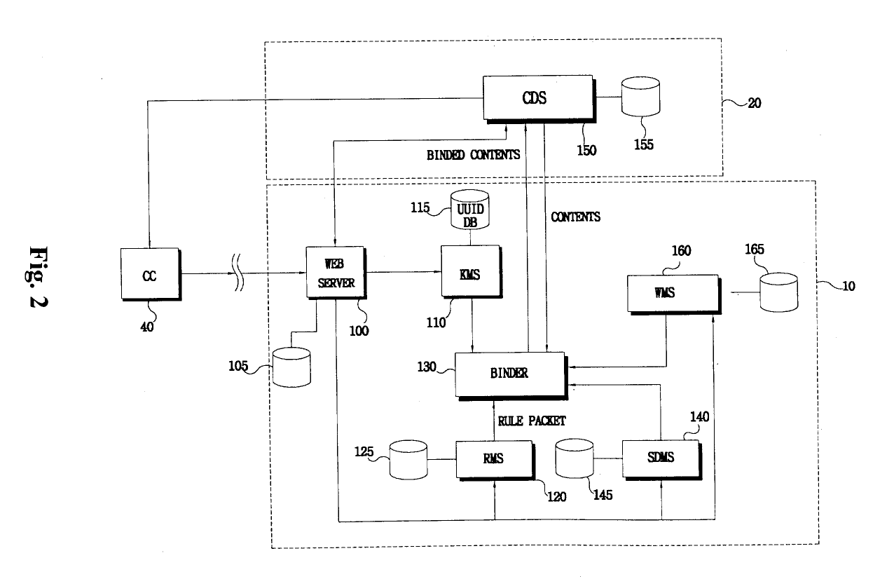

FIG. 2 is a functional block diagram illustrating the detailed constitution of system for protecting and managing the digital contents according to the present invention. FIG. 2 illustrates, in more details, constitutions of CPM (10) generating, managing and providing particular materials according to registration of CC (40) and request by CC (40), and of CD (20) to be provided to CC (40) upon receipt of the requested digital contents from the CPM (10). FIG. 2 indicates the connection relationship between each of the constituent element by a process according to the aforementioned motion. Thus, the connection relationship can be changed according to each form of motions described later.

The aforementioned constitution is examined hereinbelow in division of CPM (10) and CD (20).

CPM (10) is basically connected with CC (40) via internet, and comprises a web server (100) providing various service according to the requests by CC (40) and CD (20); database for web server (105) storing basic information with regard to users connected to the web server (100); key management server (KMS; 110) generating and managing individual's unique key according to the individual system information of the registered CC (40); user unique ID database (UUID DB) (115) which is database for key management server storing related information such as system information, etc. regarding unique key generated by key management server (110) and CC (40); rule management server (RMS) (120) generating information with regard to various rules concerning digital contents to be provided to CC (40); database for rule management server (125) storing information concerning the aforementioned; and a binder (130) for generating rules in the form that can be provided to CC (40) by receiving encrypted digital contents from CD (20) according to CC (40)'s request and by combing them with the rules that will be mentioned later.

The system generally describes the relationship between CC (40) and CD (20) providing the digital contents, but additionally, the author who originally produced the digital contents can be applied thereto. That is, the contents producer can participate as the constituent element of the above system. In such case, since the entire system have to separately prescribe the relationship among the original author, work provider, and the final user, a super distribution manage server (hereinafter, SDMS) (140) prescribing and managing such relationship separately for the aforementioned case, and a database for super distribution management server (145) storing data related thereto can be additionally equipped therewith.

For reference, two distribution routes in the distribution management are presented hereinbelow.

First, supposing that the contents author is A, A distributes his/her own digital contents to CP. Then, CP distributes the digital contents to individual end user. According to such distribution process of the digital contents, a process of A's first distributing the contents to CP is the ‘distribution process’ mentioned in the present invention.

Even such distribution process requires a rule, and such rule is not the rule directly controlling the digital contents, but a rule applied to the first distribution. Thus, in fact, such rule can be deemed as rule applied by contract between two parties. Accordingly, if the present system is applied having A and CP as its objects, a separate super distribution management server can be made and operated. However, the system is usually operated between CP and individual user, and thus only a rule for directly controlling the digital contents is sufficient.

Second, the ‘distribution process’ of the present invention is used in the sense of the following.

The distribution process in this regard refers to a process distributing certain digital contents from user C to user D. That is, when a person referred as C obtains a certain digital content in a rightful manner, C re-distributes the contents to another user D. Such distribution rule is set by a certain contract between the content owner and a person who desires to use the content. As the aforementioned explanation, when the original digital contents owner distributes to CP, the prescription of a rule such as ‘CP1 cannot distribute to other CP2’ is also a distribution rule, and the prescription of a rule providing that User C rightfully receiving the digital contents from a certain CP cannot re-distribute the digital contents to other User D can be a distribution rule arranged by CP in his/her aspect. Such can usually be a rule, but in the aspect of a rule concerning re-distribution, it can also be distribution rule.

Accordingly, the contents owner's prescribing how he/she should arrange rule in providing the digital contents to other may be a problem to the concerned users, but it will not eventually cause any problem in the contents itself.

Such distribution rule as explained above, can be arranged only by rules directly controlling the contents. Thus, it is also possible to take role of the super distribution management server only by the rule management server.

Next, CPM (10) may include a separate watermarking server (hereinafter, “WMS”) (160) for indicating copyright regarding the digital contents, and database (165) stored with materials related to the watermarking. The watermarking with regard to the digital contents can be carried out together with encryption with regard to the pertinent files when the work is uploaded. Methods used for watermarking can be found in various forms of watermarking methods in addition to those of Korean Patent Nos. 289365, 285077, etc. which are filed by the present applicant and enclosed herewith for reference.

CD (20) includes contents data server (hereinafter, “CDS”) (150) for managing digital contents provided by digital contents providers and database for CDS (155) for storing the pertinent digital contents.

The above constitution illustrates the relationship between CPM (10), CD (20), and CC (40), and with regard to the functional characteristics and the constitution of the detailed constitution, the process from the registration by user to the process of the pertinent user's downloading of particular digital contents are described hereinbelow for each of the processes in reference to the drawings regarding their pertinent constitutions.

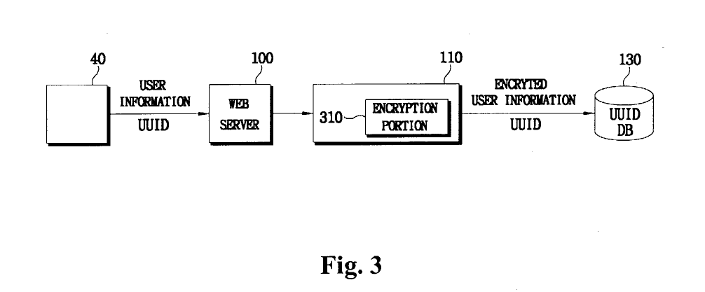

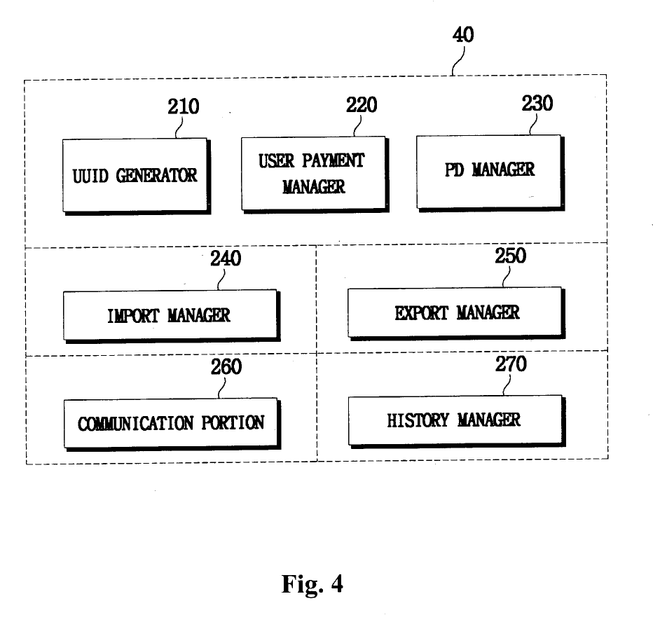

First, referring to FIGS. 3 & 4, key generation according to the present invention is described hereinbelow. FIG. 3 is a schematic block diagram illustrating the constitution for user registration of the contents protection system of FIG. 2, and FIG. 4 is a functional block diagram illustrating the function of user program downloaded to the user system and executed for user registration in FIG. 3.

The key is automatically generated by CC (40) to connect to a site offered from the web server (100) using internet in order to join as a member to the service provided by the present system and to complete user registration. Of course, when the existing CC (40) changes the system, the key can be generated by revising his/her information. The user in order to download the digital contents connects to the pertinent site and takes basic steps for user registration. When the user provides necessary information such as his/her personal information or payment approval information, and requests for registration, a user program for generation, etc. of user unique ID (UUID) is downloaded to user, i.e. CC (40) and simultaneously, the program is executed for collecting information from the CC (40)'s side.

According to the functions executed in the user program per block, as illustrated in FIG. 4, the present invention comprises user unique ID generator (210) for generating unique keys; user payment manager (220) for managing overcharge, etc. of the digital contents requested by user; portable device (PD) manager (230) for installing channels for managing information between user system and portable system such as PDA device; import/export manager (240, 250) for managing rights when rights regarding the digital contents are assigned; communication division (260) performing transmission/receipt of data with CPM (10); and history manager (270) for storing information regarding data transmission/receipt with CPM (10), PDA device, etc. The user unique ID generator (210) and communication division (260) are inevitable constituents in the above user program basically for digital content request with CPM (10), and information transmission/receipt, etc.

The user unique ID generator (210) of the user program executed by CC (40)'s side automatically extracts system information pertinent to unique characteristics of the user system, and generates user unique ID keys. In this regard, so called user unique ID key refers to unique information of the system, for example, ID of the processor, or particular unique key obtained from using unique characteristics of the system such as ID of the hard disk, etc.

The constituents comprising the computer system are central processing unit (CPU), random-access memory (RAM), hard disk (HDD), various device, etc. First, each of the chips with higher capacity than Pentium III that is the central processing unit has their unique ID, and the manufacture information (IDE) of the hard disk, when examining the physical sectors of the master area can be found, and a search for ID of the system board is also possible. The manufacture information includes information regarding name of the manufacture, serial number, model number, etc. With regard to the serial number, the same numbers used by manufacture A, manufacture B, etc. can be overlapped (the RAM which is memory does not have unique ID).

Also, when using the above system, the ID of network card can be used as unique information since network is used and in link therewith. Thus, by extracting information indicating characteristics of the system, unique user ID is generated based on such system information.

When user unique ID keys are generated as such, the user program from the CC (40)'s side uses the communication division (260) to deliver user unique ID keys to the key management server through the web server (100) together with the user information. At this moment, delivery of user unique ID key as well as the user unique ID key generation is stored in the disclosed black box having function of blocking in order for the external confirmation to be impossible, and after the storage, is delivered. Also, using the existing encryption methods, delivery can be made after encryption.

Algorithm for user unique ID key generation indicating the characteristics of the system can be realized by various methods. The user unique ID key generated is not remained in the registry for security maintenance, and user program provided from the present invention generates user unique ID keys from the information searched from the system information whenever the digital contents are played so as to undo the encrypted digital contents. Of course, when generating the user unique ID key, the black box is built-in so as not to be exposed externally. According to such series of process, the digital contents purchased by particular CC (40) by the generated user unique ID are controlled not to be able to be used without authenticated permission even when distributed to other users. In this regard, such is specifically described in the later description related to the download of the digital contents.

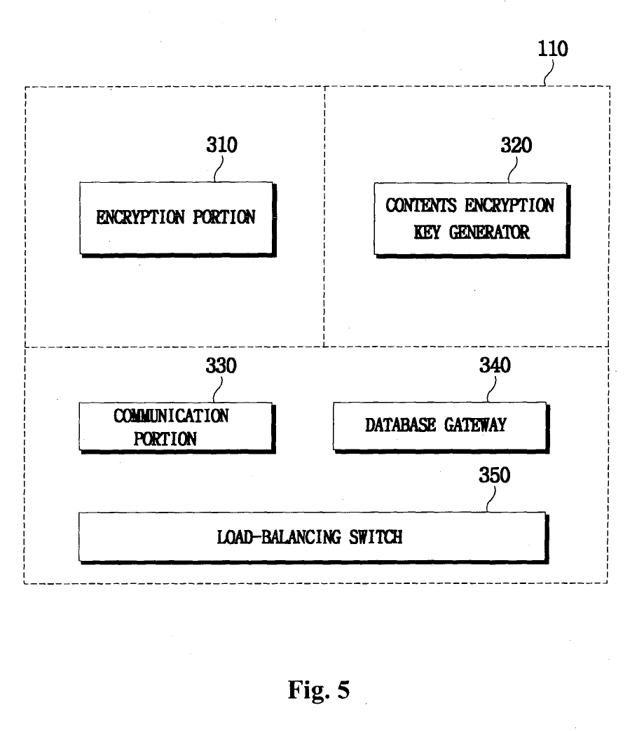

Referring to FIG. 5, the constitution and function of KMS (110) are described. As illustrated in FIG. 5, KMS (10) comprises encryption portion (310) for encrypting information in order to store user unique ID database (UUID DB) (115) connecting user to KMS (110); contents encryption key generator (320) for generating key encrypting the digital contents to be stored in the contents database (155); communication division (330) performing function for communication between other constituent elements; database gate (340) performing role of the interface for connection with the widely used commercial database; and load-balancing switch (350) performing a role of regulating load constitution between constituent elements by monitoring efficiency of the central process unit and memory.

KMS (110) comprising the aforementioned functional constituent elements stores user information and user unique ID key which were delivered through the web server (100), and encrypted by the encryption portion (310) in the user unique ID database (115) connected through database gate (350). The encryption performed in the encryption portion (310) uses a predetermined sized bit as encryption key (Pk) to carry out the encryption. For such encryption, various encryption algorithms that have been commercialized can be used, and for example, two fish encryption algorithm, or blowfish encryption algorithm and other advanced encryption standard algorithm can be used.

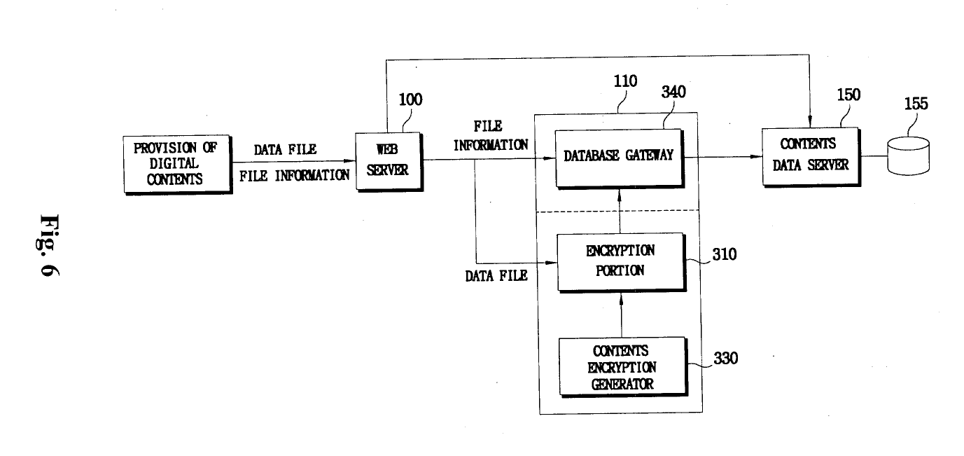

In order to accomplish action regarding the system according to the present invention, the digital contents provided to CC (40) apart from storing information regarding user information of the user, i.e. CC (40) and information regarding the user unique ID key should be equipped therewith. Hereinbelow, a process uploading such digital contents is examined in reference to FIG. 6.

As illustrated in FIG. 6, in order to make the digital contents that are the work produced by the authors to be usable for the system according to the present invention, the following processes should be carried out. First, the digital contents are uploaded according to the general method. When being uploaded, data file regarding the pertinent digital contents and content information which is bibliographical matters regarding such data file are entered together and uploaded. For example, in case of music file, general information related to the music (information such as name of recording company, name of singer, publication date, etc.) together with information regarding compression, information regarding duplication, information regarding the current music form, etc. is added. The additional information makes random bit as long as the length of the key length bit, and afterwards, the auxiliary information (Aux Info) regarding the music is entered in plain text.

The data uploaded as such are stored in the database (155) of the contents data server (CPS; 150). And, the contents data file by using the encrypted key generated from the contents encryption generator (330) executes the encryption from the encryption portion (310). Information regarding digital contents which is the data file encrypted as aforementioned and data file, is stored in the data base (155) of the content data server (150) through database gateway (350).

With regard to the above case, the upload regarding the digital contents was carried out after the encryption was performed beforehand through KMS (110). However, the digital contents can be directly transferred to contents data server (150) through the web server (100), and stored in the database as raw data. In this case, at the user's request of contents, the encryption is carried out from KMS (110) in real-time so as to be encrypted with various information, and the digital contents bound by binder (130) are provided to CD (20).

The database gateway (350) is for interface between the commercial database and other application programs, and such module is to link the commercial database to application program module. With regard to such matter, various forms for connection with database have been already provided.

Also, digital watermark before the process such as encryption regarding digital contents can be inserted. The insertion of watermark is carried out by a method of inserting watermark for intellectual property information in order to track digital contents afterwards. Furthermore, trigger bits based on a method requested by technique adopted as the standardization technique, are inserted. For reference, when there is an attempt to revise data being protected, the trigger bits are a special form of stored procedure automatically executed. The trigger bit is a bit acting as a series of signals, and plays a role to operate and carry out a particular procedure when there are certain external stimulus such as compression regarding the digital contents.

After the embedding of watermark, compression is carried out in order to reduce the size of the file regarding the digital contents.

In the above description, the state in which after the digital contents are generated, and encrypted, the contents are uploaded and built beforehand as database, is explained. However, when the above process is not carried out, and the user requests a certain series of contents, the contents may after the contents are requested so as to be encrypted in real-time immediately, undergo a series of the subsequent processes to be downloaded to the user.

A case in which there is a request for download of the digital contents from CC (40) at the state when the aforementioned information regarding user and information regarding user unique key are already stored, and also the digital contents and information thereto are already built through the author, etc., is examined referring to FIGS. 2 & 7 to 11.

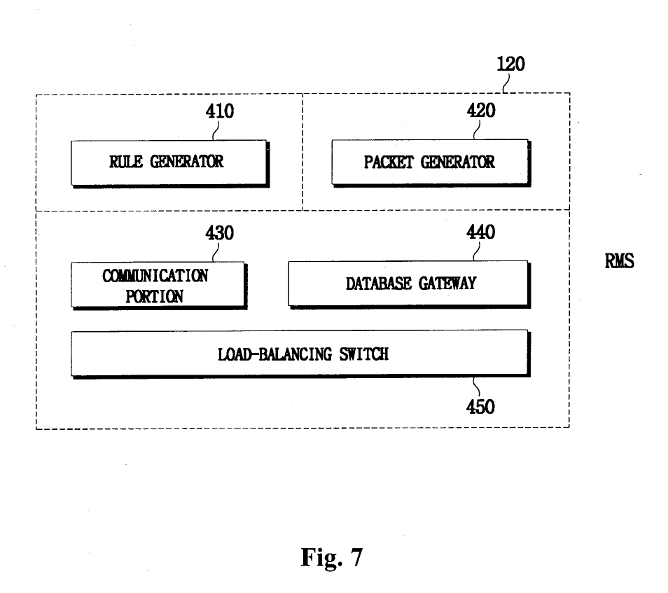

First, before the case of the downloading, functions of the rule management server (hereinafter “RMS”) and the super distribution management server (hereinafter, “SDMS”) are examined referring to FIGS. 7 & 8 which illustrate the functions per block.

RMS (120) of FIG. 7 will omit the detailed explanation with regard to constituent elements identical to those of KSM (110) of FIG. 5 from comparison. The rule generator (410) generates rules based on rules stored in the rule database (125) and information of user's authority, and the packet generator (420) generates communication packet to be provided to the binder (130). In this regard, rules refer to rules regarding the authenticated user's use of information. That is, when information is circulated and used, rules refer to designation of the level and range of authority according to each of the individuals, and designation of allowable perusal, use, print-out, circulation of information to certain range at certain stage.

The above rules are not designated and fixed beforehand, but determined according to each of the requirements in the aspect of managing information by applying the present system, and stored in the database. According to such establishment of rules, the manager can freely mange the rules such as addition or revision, etc. pursuant to re-distribution of digital information, and an effective provision of information and management through such is possible. Undoubtedly, the information user can use information within the authorized scope according to the determined rules.

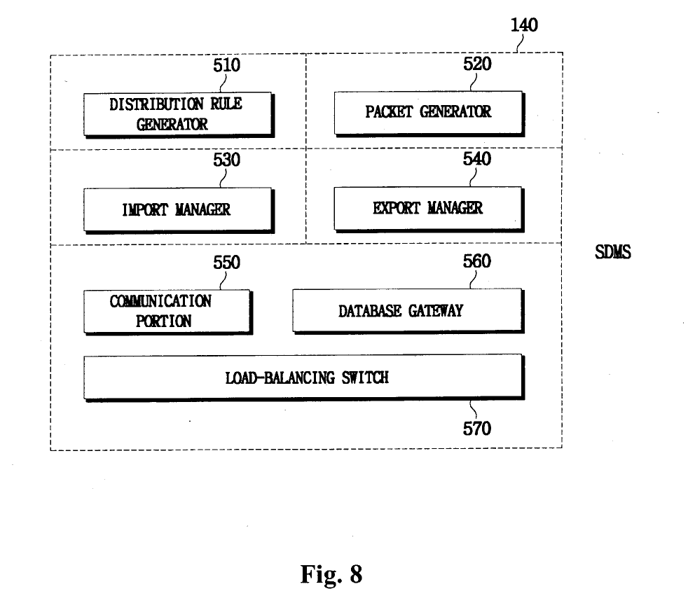

In FIG. 8, SDMS includes, other than the previously aforementioned identical constituent elements, distribution rule generator (510) for making rules regarding distribution; packet generator (520) for generating in packet form rules to be provided to the binder (130), and import/export managers (530, 540). The import/export mangers (530, 540) are used when treating the situation of assigning the right regarding digital contents by user A to other user B. Provision made at the SDMS as above is related to a distribution route in which CP re-provides (re-distributes, re-sells) the digital contents to the individual end users in case of user A as the author of the digital contents (owner, copyright owner, original author) sells (in case of distributing) his/her own digital contents to contents provider (CP). In such course of distributing the digital contents, only the first process of distribution by User A to CP is provided as ‘distribution management’.

Also, the above ‘distribution management’ can be used as the following meaning such as aforementioned explanation. It may refer to a process of distribution in which certain digital contents are assigned from User C to User D. That is, assuming that User C obtained certain contents by rightful method, User C re-distributes to other User D. Such rules are established between the owner of the contents and the person who wants to use the contents through certain contract, etc. As aforementioned, when the original content owner distributes to CP, establishing a rule such as CP1 cannot distribute to CP2 is also a kind of a rule, and establishing a rule that User C receiving the distribution of contents from a certain CP rightfully cannot re-distribute to other User D is a rule that can be established by CP's point of view.

That is, SDMS (140) receives information such as user ID, and file name, etc. from the web server (100), searches and generates the corresponding distribution management rules through query from database for super distribution management server (145), and carries out the role of transmitting packet that has been generated for delivery to the binder (130).

RMS (120) and SDMS (140) are used for managing each of the rules and distribution rules, respectively, and each has been described separately for convenience in the above. However, actually, as previously mentioned, they can be employed by using one RMS.

A process of downloading the data by CC (40) with regard to the system having the aforementioned constitution is described in details referring to FIGS. 2, 4, 5, 7 & 8.

CC (40) connects to the web server (100) through internet. The web server (100) can be connected through user authentication process generally used in the pertinent site or authentication using officially-adopted authentication. CC (40) at the state of such connection either selects his/her desired digital contents on the screen for downloading of materials by using web browser, or requests particular file name. When downloading of material is requested as such, user ID regarding CC (40) and file name regarding the pertinent digital contents are delivered to KMS (110) and RMS (120), SDMS (140), WMS (160) and CDS (150) through the web server (100).

When file request is made as the name of the digital contents to be downloaded to CDS (150) is transmitted, CDS (150) searches database (155) connected thereto, finds the pertinent file, and transmits to the binder (130). At this time, if indication of the information regarding copyright of the digital contents is desired, watermark is inserted through WMS (160), and afterwards, the information is transmitted to the binder (130). Also, KMS (110) detects user unique ID by using user information obtained from particular information of the user system at the time user registers previously from the UUID database (115) storing information regarding user and user unique ID (UUID).

When user ID and file name are transmitted to RMS (120), rules are searched and generated through query processing regarding rule database (125) according to such information. In order to generate data in a packet-form data, a packet is made using the packet generator (420), and afterwards, the data are transmitted to the binder (130). In this regard, rules refer to rules regarding the authenticated user's use of information. That is, when information is circulated and used, rules refer to designation of the level and range of authority according to each of the individuals, and designation of allowable perusal, use, print-out, circulation of information to certain range at certain stage.

The above rules are not designated and fixed beforehand, but determined according to each of the requirements in the aspect of managing information by applying the present system, and stored in the database. According to such establishment of rules, the manager can freely mange the rules such as addition or revision, etc. pursuant to re-distribution of digital information, and an effective provision of information and management through such is possible. Undoubtedly, the information user can use information within the authorized scope according to the determined rules.

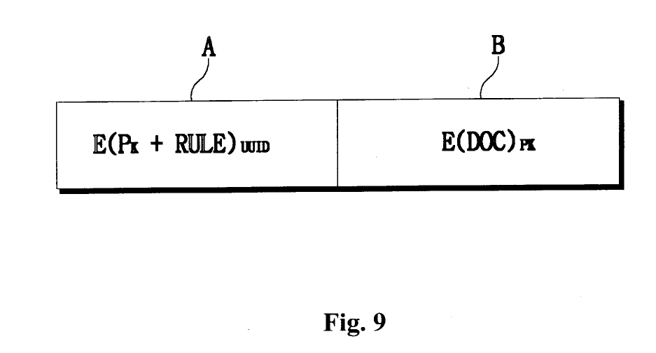

According to the above user's request for information provision, the user unique ID from the UUID DB (115) having information regarding the unique key, the rule packet regarding rules from RMS (120), and digital contents encrypted from the CDS (150) are delivered to the binder (130), respectively. That is, the binder (130) can carry out the encryption in real-time when the digital contents provided from the CDS (150) are a binary format file that is in encrypted state or as previously mentioned, a low data format that is provided from CD (20). The related information which can control file from the header portion of the file encrypted as above is attached completing a single joint file so as the digital contents bound as such are downloaded to CC (40) through CDS (150). In this regard, the information attached to the header portion of the encrypted file is comprised of a ‘user rules+file decryption key’ form. Naturally, this information is not merely joined, but encrypted once as user unique ID, and joined to have a form illustrated in FIG. 9.

Rules among the information attached to the header portion include information, for example, copy control information (hereinafter, “CCI”) if the pertinent data is audio digital contents, maximum copy number (MCN), intellectual property rights, and music ID, etc., and concretely have the following values.

CCI: comprised of 2 bits, and in combination of four different bits. Each indicates information such as ‘Copy Free’ (CCI=00), ‘Copy One Generation (01)’, ‘Copy No More’ (10), ‘Copy Never’ (11), etc. ‘Copy No More’ corresponds to a case in which ‘Copy One Generation’ is over the range of the limited duplication range, and ‘Copy Never’ corresponds to a case in which the duplication of the original music itself is prohibited.

In this regard, when the designated 00, 01, 10, 11 are provided in the order of 00, 01, 11, 10, they can further be easily changed based on the basic principle of the Gray Code. (For reference, in the Gray Code, the front/rear code has a characteristic of changing only one bit, and thus has an important characteristic of noting the error of the system receiving analog materials having consecutive characteristics by input. Thus, the Gray Code is used widely. The Gray Code is a non-weighted code, and is used for analog-to-digital converter).

MCN: effective when only in ‘Copy One Generation’, and is allocated with four bits.

IRI: intellectual property rights information, and the allowable bit can be designated according to request. The intellectual property rights information inserted can be designated by combining name of the music file, name of the singer or license owner, etc.

Music ID: represents ID regarding music files.

The header including the above information conceals the 128 random bits into pad (i.e., header bits+random bits=128 bits).

The file joined and generated as the above is downloaded and delivered to CC (40), and the filed transmitted to CC (40)'s side can be used in the application program.

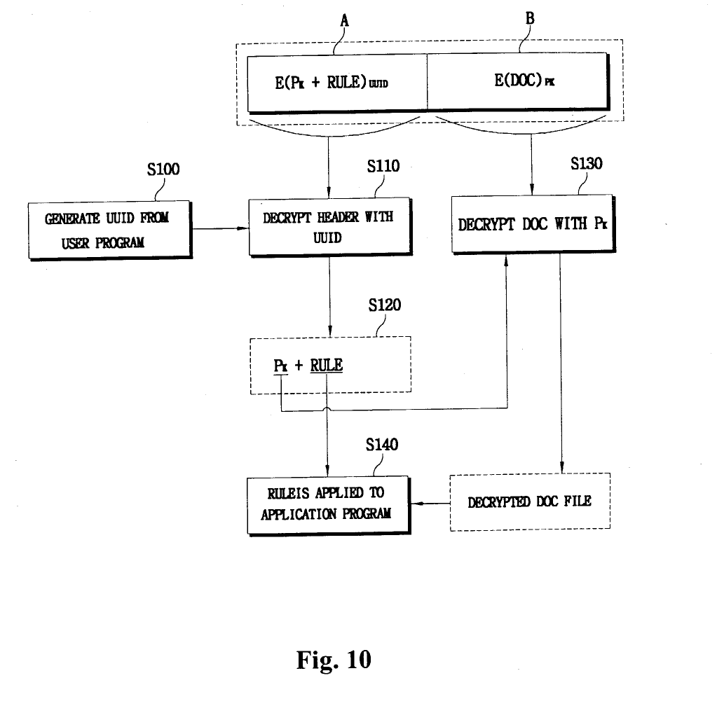

CC (40)'s side can use file requested through a process such as that illustrated in FIG. 10. Referring to FIG. 10, the above is examined in more details. First, the transmitted file as aforementioned is divided into header portion (A) and data portion (B). Between the divided data, the header portion (A) is decrypted using user unique ID. At this time, the generation of the user unique ID is in the middle of carrying out the user program installed in the CC (40)'s side, and thus, by using user unique ID generator (210) from such program, user unique ID is generated (S100), and the header portion (A) is decrypted by using such (S110).

Undoubtedly, the decryption is basically accomplished when UUID used for encryption in the server's side before downloading corresponds to the UUID generated by the user system, and when the UUID generated from the user system does not correspond to the UUID from the downloaded data, the user is notified with no authority to use the current downloaded file through message, etc. As such, the user program calculates UUID from the hardware information of the user computer system every time it is executed, and stops its execution when the calculated UUID is different from the UUID included in the downloaded digital contents. By doing so, the user system is prevented from being moved as it is and executed in other user's system.

By using the aforementioned UUID, the decrypted portion is divided into the encryption key (Pk) and rules (S120), and data portion (B) transmitted when downloading by using the encryption key (Pk) thereof is decrypted (S130). The decrypted raw data are not recorded in the disc of the user system in decrypted state for security or protection of copyright data, but are made to exist only in memories.

When the rules and raw data are obtained as such, the raw data are used in the application program, and the condition for use is determined by the rules. For example, if the data are audio digital contents (MP3), the digital contents can be regenerated by using application program which is a music generation program when the form of raw data decrypted and usable is obtained. Also, according to the rules, the control regarding the raw data can be accomplished, for example when the raw data are document and order such as save, print, etc. is rendered, print order may be returned according to the rules, or save order may be returned. If save order is permitted, whether the data is saved as document or is encrypted and saved, etc. is determined and controlled by rules.

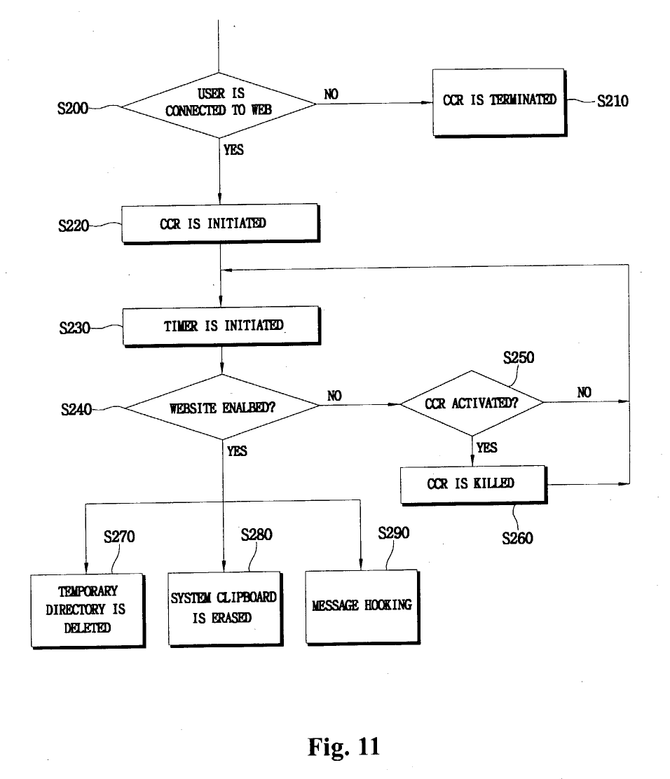

The architecture and the action of the contents controller (CCR) mentioned in the previous description of the whole constitution is described referring to FIG. 11.

CCR (50) executes its action, during the circulation process of the contents provided, managed and generated by CPM, when CC visits home pages managed by CPM, and peruses the digital contents. In such state, the home pages and a series of keyboard, mouse functions can be controlled by using CCR. For example, when CCR connects to the on-line education system and peruses contents related to education provided from such sites, the contents provider allows CC only to peruse the education contents, but prevents CC from acts of copying or saving in CC's computer, printing out as print-outs, or capturing the screen, etc. Such is to prevent CC from using or printing out the contents without permission when CC did not undergo the rightful purchase process or process of use. Such is explained in FIG. 11 in details.

First, user connects to home page provided from CPM through web browser. As the home page is opened, CCR provided from the present invention is simultaneously activated to control the overall actions. That is, when the user is connected to the CC's home page, CPM automatically initiates the CCR (S200). Also, in a case of the user moving from the home page to other site, CCR is closed.

At the stage the CCR is initiated, the initiation of timer is made (S210). The role of timer is to check whether the window to which the pertinent home page is indicated is enabled continuously on CC's terminal (monitor, etc.) while the home page is operating in the activation state (S220). That is, the window including the digital contents provided with protection by CPM is checked for whether it is an activated window (that is, whether the window is displayed in front and whether the type tool bar is blue on the monitor).

If CC looks at the window including the contents, but does not use it, whether CCR is in active state is checked (S220), and in case of active state, CCR is killed (S240), and in case of non active state, returns to activate the timer, and returns to the first process of checking whether the window is in active state so as to perform such task repeatedly. That is, among the multiple windows appearing on the monitor, in case of the window indicating the service according to the present invention is in active state, i.e. in case the active window is the main window, the function of CCR is carried out.

The majority of functions carried out in CCR is conducted by using the window hooking function. The hooking, in short, forcefully snatches the window procedure of all process and replaces it. That is, the hooking makes an intrusion to space of other procedure which is not the space within its own procedure, and replaces it at one's will.

When CCR's function is initiated as a result of the above determination, the function of clipboard control, temporary directory deletion is carried out by the internal timer. Such two processes are repeatedly carried out continuously by the internal timer in a certain duration of hours. And, when an event occurs by pointing device such as keyboard typing or mouse, etc. by CC, the message hooking is carried out. The message hooking includes keyboard hooking, mouse hooking, window hooking etc. According to the keyboard hooking, the functions such as saving, copying, screen capturing, etc. are controlled by keyboard input, and in the same manner, the functions such as saving, copying, seeing html source, etc. are controlled by mouse hooking.

With regard to the examples mentioned above, the temporary directory deletion function means that when the internet Explorer which is a kind of web browser program by Microsoft Inc. is executed, at the connection to the particular web sites, data provided from the pertinent web sites and displayed on the monitor generate a temporary directory in the user's computer for prompt display when repeatedly used, and the data displayed in this directory are downloaded automatically. That is, the contents of the various data provided by CC are automatically saved in the user's computer. Thus, the function of the present CCR is to periodically delete the contents of the temporary directory generated as the above so as to prevent saving the digital contents in the user's computer without control by CPM and to protect the digital contents. Such directories are generated according to the predetermined rules per application system, and thus, the existence of the temporary directories can be known by examining the rules of the application system.

Also, the system clipboard of the computer can use PrtSc key, etc. of the computer and copy the contents displayed in the present screen. Thus, when the video information of which CD has the copyright is displayed on the screen, the user can use PrtSc key and copy the video information on the system clipboard, and afterwards, can edit and use it again. Accordingly, in order to prevent such illegal duplication, the digital contents can be protected by deleting the contents saved in the system clipboard.

And, with regard to the message hooking, the window operation system has its whole orders delivered in messages. The message generated by user is saved in the message queue, and the window approaches the message queue to read the message and execute the orders. Thus, during operation of CCR, in order to protect the digital contents, hooking of the message input by user is carried out, and the examination of whether particular message is included among these messages (for example, copy of the data, etc.) is made. When particular message is included among the messages as a result, the particular message is deleted in the message queue, and the remaining portions are processed in the window so as to prohibit orders made without permission of CPM.

By the function carried out by the above series of CCR, CC is considered to receive the first restriction in perusing and using the contents on the home page provided by CPM. This first restriction may bring partial inconvenience since restriction is made on carrying out the functions on the browsers from CC's side, but from the CPM's side which provides contents, it is the first reliable solution to safely open and provide a good quality contents. Further, managing the protection, distribution and circulation system, etc. of the contents themselves for the second time can be proceeded by CPM as mentioned above.

As aforementioned, the contents protection and management system (CMS) provided by the present invention can be modularized and provided in order to make interface of each portion possible for enabling service through integral connection such as the conventional DRM function+watermarking+mobile agent+authentication, etc. And, CMS minimizes the roles of the server and client, and is a specialized form of system by CPM. CMS can let all matters be managed from CPM server.

Currently, for Korea and Japan, the owners of the contents are reluctant to let others manage their contents. In this regard, the CMS provided by the present invention allows CPM server to manage all of contents and user key, contents encryption key, etc., which has added flexibility to its operation. Also, as the key management section manages the user's settlement details, and user's information, CPM can utilize these to advertisement and publicity, and can proceed with advertisement using watermarking technique.

The present invention minimizes the capacity of the general user's program (viewer) so as to pursue convenience by reducing the time for downloading, and can optimally minimize it into a model which can be usable even with the limited capacity of the mobile device such as mobile phone, etc. That is, in order to be applicable to the screen of the mobile phone, etc., the system of the present invention is flexibly created in order to consider, from the time of its design, its suitable application to mobile devices such as minimization of the size of the viewer and realization into JAVA, etc. Particularly, the system provided by the present invention can be manufactured by JAVA application, which is to realize the function suggested above into chips so as to be built in, only interface should be realized.

And, we would like to clearly state herein that the ‘digital contents’ of the present invention refers to the various contents inclusive of image, audio, video, e-Book contents, digital education related contents, broadcasting contents, etc.

An on-line route using wire/wireless communication can be used for the route for distributing contents, but according to the needs, an off-line route of delivering directly can also be used. In the aforementioned invention, the provision of the contents and the purchase, etc is carried out on-line, and downloading of a series of programs and contents is also carried out on-line.

Nevertheless, according to the conditions, the digital contents can be saved through a saving mediums such as floppy disc, compact disc, DVD ROM, laser disc, etc. so as to be circulated off-line. Even when the contents are circulated off-line, and CC opens or generates the contents from the terminal of his/her own computer, user unique ID keys are generated through the execution of the CPM user program, and by the generated ID, determination on the later generation of the contents and control thereof can also be made.

Additionally, CMS provided by the present invention is a management system applicable to the general electric home appliances, which can be worked to enable the expansive application. The current trend with regard to the general electric home appliances is also digitalization, and concepts of digital electric home appliances such as digital TV, digital camera, internet refrigerator, internet washing machine, etc. are appearing. In such situation, we state that CMS provided by the present invention is applied to the digital electric home appliances, which can be widely applied to all digital electric home appliances receiving or transmitting contents.

The aforementioned system for protecting and managing digital contents according to the present invention is an integrative system protecting and managing contents throughout the whole process, i.e. from a process from which work in digital contents is generated to a process of its circulation, which provides the following effects according to the operation of such system.

First, the system enables easy harmonization to systems already built, application thereto for practical use. The existing digital rights management (DRM) on the whole has a very complicated management structure system in its structural constitution, and thus it has an aspect for not an easy introduction and working of the system by ordinary CP traders. CPM suggested by the present invention is designed to enable harmonization and application to any system without any burden. Particularly, the constitution thereof is not complicated, but simple so as to have advantage over in the aspect of speed of the system, which enables easy application to mobile device, etc. Henceforth, the system is considered very easy to apply to the protection and management of the mobile contents.

Next, the present system provides accurate and specialized performance/ability of its own. First, the conventional DRM had a shortcoming in which the raw contents with their codes broken are caught by illegal users via certain method and device so as to enable re-processing and re-distribution. However, the present invention enables for the raw contents with their codes broken to be automatically concealed as author's information with watermark at the original creation of the contents. Accordingly, the contents, even in a state of their codes broken, always have the information regarding copyrights, etc. remained therein so as to be able to protect the copyright. Description with regard to such matter will be made later.

Most of the currently circulated digital contents are exposed to illegal duplication or circulation, and thus the copyright of the authors is infringed, which also acts as a factor obstructing the healthy growth of the electronic business transactions. In such situation, through the working of the present invention, the content producer can have his/her ownership, copyright regarding the contents protected, and be assured of the contents produced by him/her being distributed and used in the right circulation structure. Such is the base for accelerating contents production of good quality. The contents distributor (may be the same person as the content provider) can build contents protection, management system according to the present invention, and can manage it so as to be surely insured of rightful profit from the contents distribution.

From the point view of the contents purchaser (user), he/she is able to use contents with a good quality through reliable services. Through the working of the present invention, the copyright of the owner regarding the digital contents is fundamentally protected, and illegal use, surreptitious use, etc. are fundamentally prevented so as to assure trust between participants to the trade. Furthermore, contribution to invigorate the nurturing of the good-quality digital contents based on trust can be made, the development of the electronic business transaction can be further accelerated, and a new business model can be suggested.

The present invention is specially illustrated and described referring to the above embodiments, but such is used for examples. In this regard, a person having ordinary skill in the pertinent art can make various revisions without deviating from the spirit and scope of the invention as defined in the claims attached herewith.

What is claimed is:

1. A system for protecting and managing digital contents, comprising:
at least one user system on which means for generating a unique key is provided, said unique key being determined from a unique information of said user system;
a digital contents provider which contains a plurality of digital contents; and
a contents protection manager for encrypting a encryption key used to encrypt said digital contents and usage rule on said digital contents with said unique key and combining them with said digital contents, thereby providing a combined data to said user system.

2. The system for protecting and managing digital contents according to claim 1, wherein said contents protection manager comprises:
rule management means for managing a data regarding usage rule of said digital contents;
key management means for managing said unique key, encrypting said digital contents using said unique key, and generating/managing said encryption key for performing said encrypting therewith; and
binding means for encrypting said usage rule and said encryption key with said unique key and combining them with said digital contents encrypted with said encryption key.

3. The system for protecting and managing digital contents according to claim 2, wherein said contents protection manager further comprises means for watermarking, said watermarking being performed prior to provision of said digital contents to said binding means.

4. The system for protecting and managing digital contents according to claim 1, wherein said user system divides said combined data into said encrypted digital contents and header, decrypts usage rule and a encrypted key from said header using said unique key, and decrypts said digital contents using said decrypted encryption key, thereby making said decrypted digital contents in accordance with said usage rule available.

5. The system for protecting and managing digital contents according to claim 4, wherein said usage rule is a rule for utilizing said digital contents in said user system.

6. The system for protecting and managing digital contents according to claim 4, wherein said user system decrypts said encrypted digital contents only when said unique key generated in said user system is identical to a unique key contained in said combined data.

7. The system for protecting and managing digital contents according to claim 4, wherein said unique key is from at least one of processor's ID, hard disc's ID, network card's ID, system board's ID or the combination thereof.

8. The system for protecting and managing digital contents according to claim 4, further comprising means for controlling operation of said user system so as to protect said digital contents displayed on a terminal or a browser of said user system.

9. The system for protecting and managing digital contents according to claim 8, wherein said means for controlling user's system checks system clipboard repeatedly in a predetermined duration of time using a timer provided inside said user system and deletes content contained in said system clipboard, said means for controlling using window hooking function.

10. The system for protecting and managing digital contents according to claim 8, wherein said means for controlling user's system deletes data downloaded into temporary directory repeatedly in a predetermined duration of time using a timer provided inside said user system, said means for controlling using window hooking function.

11. The system for protecting and managing digital contents according to claim 8, wherein said means for controlling performs message hooking function in case of the event by keyboard or mouse, and, in case of the event of message related to copy or print of said digital contents among messages inputted into said message queue, deletes the corresponding message from said message queue.

12. The system for protecting and managing digital contents according to claim 4, wherein said rule management means comprises:
rule generating means for generating usage rule based on characteristics of said user system; and
packet generating means for generating a packet for transmitting said usage rule to said key management means.

13. A system for protecting and managing digital contents comprising a user system, a digital contents provider for providing digital contents, and a contents protection manager for providing said digital contents from said digital contents provider to said user system,
wherein said user system generates a unique key by extracting unique system information of said user system, and decrypts said digital contents using said unique key,
wherein said digital contents provider stores encrypted digital contents, and provides said digital contents responsive to request of said contents protection manager,
wherein said contents protection manager makes usage rule on said digital contents and stores information of said user system along with said unique key,
wherein said contents protection manager encrypts user information on said user system and said unique key, and then writes them in a unique key database,
wherein said contents protection manager encrypts an encryption key used to encrypt said digital contents and said usage rule with said unique key, and combines them with said encrypted digital contents so as to provide it to said user system.

14. The system for protecting and managing digital contents according to claim 13, wherein said digital contents manager further comprises watermarking means for watermarking said digital contents, said watermarking being performed prior to compression of said digital contents.

15. The system for protecting and managing digital contents according to claim 13, wherein said digital contents manager further comprises watermarking means for watermarking said digital contents, said watermarking being performed prior to combination of said digital contents with said usage rule.

16. The system for protecting and managing digital contents according to claim 13, wherein said user system divides said digital contents into a header portion and a data portion, decrypts usage rule and a encryption key from said header portion using said unique key, and decrypts said data portion using said decrypted encryption key, thereby using said digital contents in accordance with said usage rule.

17. The system for protecting and managing digital contents according to claim 14, wherein said user system decrypts said data portion only when a unique key from said user system is identical to a unique key contained in said digital contents.
